(19) United States
(12) Patent Application Publication
(10) Pub. No.: US 2019/0256694 A1
(43) Pub. Date: Aug. 22, 2019

(54) RUBBER COMPOSITION FOR TIRE AND PNEUMATIC TIRE USING SAME

(71) Applicant: Toyo Tire Corporation, Itami-shi, Hyogo (JP)

(72) Inventor: Fumihiko Nakamura, Itami-shi (JP)

(73) Assignee: Toyo Tire Corporation, Itami-shi, Hyogo (JP)

(21) Appl. No.: 16/346,551

(22) PCT Filed: Dec. 7, 2017
(86) PCT No.: PCT/JP2017/043966

§ 371 Date: May 1, 2019

(30) Foreign Application Priority Data
Dec. 15, 2016 (JP) 2016-243410

(51) Int. Cl. C08L 15/00; C08C 19/02; B60C 1/00

(52) U.S. Cl. CPC C08L 15/00; B60C 1/0025; C08C 19/02

(57) ABSTRACT

Provided a rubber composition for a tire that can have both ozone resistance and good appearance, and a pneumatic tire using the same. A rubber composition for a tire comprising a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, wherein the rubber composition does not substantially contain a chemical age resister.

### TECHNICAL FIELD

The present invention relates to a rubber composition for a tire and a pneumatic tire using the same.

### BACKGROUND ART

Pneumatic tire is deteriorated by the influence of oxygen, ozone and the like in the air during long-term use. As a result, cracks are generated in a groove bottom of a sidewall part and a tread part, and this causes deterioration of durability. To improve ozone resistance, a chemical age resister is sometimes added. However, the chemical age resister is excessively precipitated on a vulcanized rubber surface of a tire, leading to generation of blooming and discoloration of a tire surface. Thus, the chemical age resister has the problem that appearance of the tire is impaired.

Patent Documents 1 to 4 disclose using a hydrogenated copolymer in which a conjugated diene moiety of a copolymer of aromatic vinyl and conjugated diene has been hydrogenated, as a rubber component. However, a chemical age resister is used in those patent documents, and the improvement of appearance has been still required in a rubber composition using a hydrogenated copolymer.

### PRIOR ART DOCUMENTS

### Patent Document

Patent Document 1: JP-A-2003-253051

Patent Document 2: JP-A-2015-110705

Patent Document 3: JP-A-2016-56349

Patent Document 4: JP-A-2016-56350

### SUMMARY OF THE INVENTION

### Problems that the Invention is to Solve

In view of the above, the present invention has an object to provide a rubber composition for a tire that can have both ozone resistance and good appearance, and a pneumatic tire using the same.

### Means for Solving the Problems

To solve the above problems, the rubber composition for a tire according to the present invention comprises a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, wherein the rubber composition does not substantially contain a chemical age resister.

The content ratio of the hydrogenated copolymer in the rubber component is preferably 80 mass % or more.

The rubber composition for a tire according to the present invention can be preferably used in a sidewall.

The pneumatic tire according to the present invention can be manufactured using the rubber composition for a tire.

### Effects of the Invention

According to the rubber composition for a tire of the present invention, a pneumatic tire having both ozone resistance and good appearance can be obtained.

### MODE FOR CARRYING OUT THE INVENTION

The items relating to the embodiment of the present invention are described in detail below.

The rubber composition for a tire according to this embodiment comprises a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, wherein the rubber composition does not substantially contain a chemical age resister.

The rubber component used in the rubber composition according to this embodiment contains a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more. In the present description, the weight average molecular weight measured by gel permeation chromatography (GPC) is a value calculated in terms of polystyrene based on commercially available standard polystyrene, using a differential refractive index detector (RI) as a detector and using tetrahydrofuran (THF) as a solvent under the conditions that a measurement temperature is 40° C., a flow rate is 1.0 mL/min, a concentration is 1.0 g/L and an injection quantity is 40 μL. The hydrogenation ratio is a value calculated from a spectrum decrease rate of an unsaturated bond moiety of a spectrum obtained by measuring H¹-NMR.

The aromatic vinyl constituting the aromatic vinyl-conjugated diene copolymer is not particularly limited, but examples thereof include styrene, α-methylstyrene, 1-vinylnaphthalene, 3-vinyltoluene, ethylvinylbenzene, divinylbenzene, 4-cyclohexylstyrene and 2,4,6-trimethylstyrene. Those may be used alone or as a combination of two or more kinds.

The conjugated diene constituting the aromatic vinyl-conjugated diene copolymer is not particularly limited, but examples thereof include 1,3-butadiene, isoprene, 1,3-pentadiene, 2,3-dimethylbutadiene, 2-pheny-1,3-butadiene and 1,3-hexadiene. Those may be used alone or as a combination of two or more kinds.

The aromatic vinyl-conjugated diene copolymer is not particularly limited, but a copolymer of styrene and 1,3-butadiene (styrene-butadiene copolymer) is preferred. Therefore, the hydrogenated copolymer is preferably a hydrogenated styrene-butadiene copolymer. The hydrogenated copolymer may be a random copolymer, may be a block copolymer and may be an alternating copolymer. The aromatic vinyl-conjugated diene copolymer may be modified with at least one functional group selected from the group consisting of amino group, hydroxyl group, epoxy group, alkoxy group, alkylsilyl group, alkoxysilyl group and carboxyl group at a molecular end or in a molecular chain.

The hydrogenated copolymer can be synthesized by, for example, synthesizing an aromatic vinyl-conjugated diene copolymer and conducting a hydrogenation treatment. A method for synthesizing the aromatic vinyl-conjugated diene copolymer is not particularly limited, but the examples thereof include a solution polymerization method, a gas phase polymerization method and a bulk polymerization method, and a solution polymerization method is preferred. The polymerization form may be any of a batch type and a continuous type. The aromatic vinyl-conjugated diene copolymer can use the commercially available copolymers.

The hydrogenation method is not particularly limited, and the aromatic vinyl-conjugated diene copolymer is hydrogenated by the conventional method under the conventional conditions. The hydrogenation is generally conducted at 20 to 150° C. under a hydrogen pressure of 0.1 to 10 MPa in the presence of a hydrogenation catalyst. The hydrogenation ratio can be optionally adjusted by changing the amount of a hydrogenation catalyst, a hydrogen pressure when hydrogenating, a reaction time and the like. The hydrogenation catalyst can generally use a compound containing any of metals of Groups 4 to 11 of the periodic table. For example, a compound containing Ti, V, Co, Ni, Zr, Ru, Rh, Pd, Hf, Re or Pt atom can be used as the hydrogenation catalyst. Examples of more specific hydrogenation catalysts include a metallocene compound such as Ti, Zr, Hf, Co, Ni, Pd, Pt, Ru, Rh or Re; a supported type heterogeneous catalyst comprising a carrier such as carbon, silica, alumina or diatomaceous earth and a metal such as Pd, Ni, Pt, Rh or Ru supported thereon; a homogeneous Ziegler catalyst comprising a combination of an organic salt or acetylacetone salt of a metal element such as Ni or Co and a reducing agent such as organic aluminum; an organic metal compound or complex of Ru or Rh; and fullerene or carbon nanotube having hydrogen occluded therein.

The hydrogenation ratio of the hydrogenated copolymer (proportion of hydrogenated moiety in conjugated moiety diene of aromatic vinyl-conjugated diene copolymer) is 80 mol % or more and preferably 90 mol % or more.

The weight average molecular weight of the hydrogenated copolymer is not particularly limited so long as it is 300,000 or more. The weight average molecular weight is preferably 300,000 to 2,000,000, more preferably 300,000 to 1,000,000 and still more preferably 300,000 to 600,000.

The rubber component may contain a diene rubber other than the hydrogenated copolymer, and examples of the diene rubber include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The content ratio of the hydrogenated copolymer in the rubber component is not particularly limited, but, is preferably 80 to 100 mass % and more preferably 90 to 100 mass %. When the content ratio is 80 mass % or more, ozone resistance is excellent.

The rubber composition according to this embodiment does not substantially contain a chemical age resister. The chemical age resister used herein means a compound having age-resistant effect by chemical action, that is, occurrence of change in molecular level. Therefore, wax and the like that bloom on a rubber surface after vulcanization to form a coating film on the rubber surface, thereby shielding ozone and protecting a rubber are not included in the chemical age resister, and may be contained in the rubber composition according to this embodiment. In the present description, the term “does not substantially contain” means the content in a range that significant effect is not recognized by the inclusion, and although varying depending on the kind and the like of the chemical age resister, the content is generally less than 1 part by mass and preferably less than 0.1 parts by mass, per 100 parts by mass of the rubber component.

Specific examples of the chemical age resister include a quinoline type age resister, an aromatic secondary amine type age resister, a phenolic age resister, a sulfur type age resister and a phosphite type age resister.

Examples of the quinoline type age resister include 2,2,4-trimethyl-1,2-dihydroquinoline polymer (TMDQ) and 6-ethoxy-2,2,4-trimethyl-1,2-dihydroquinoline (ETMDQ).

Examples of the aromatic secondary amine type age resister include N-phenyl-N′-(1,3-dimethylbutyl)-p-phenylene diamine (6PPD), N-isopropyl-N′-phenyl-p-phenylene diamine (IPPD), N,N′-diphenyl-p-phenylene diamine (DPPD) and N,N′-di-2-naphthyl-phenylene diamine (DNPD).

Examples of the phenolic age resister include a monophenolic age resister such as 2,6-di-tert-butyl-4-methylphenol (DTBMP) or styrenated phenol (SP); a bisphenolic age resister such as 2,2′-methylene-bis(4-methyl-6-tert-butylphenol) (MBMBP), 2,2′-methylene-bis(4-ethyl-6-tert-butylphenol) (MBETB), 4,4′-butylidene-bis(3-methyl-6-tert-butylphenol) (BBMTBP) or 4,4′-thio-bis(3-methyl-6-tert-butylphenol) (TBMTBP); and a hydroquinone type age resister such as 2,5-di-tert-butylhydroquinone (DBHQ) or 2,5-di-tert-amylhydroquinone (DAHQ).

Examples of the sulfur type age resister include a benzimidazole type age resister such as 2-mercaptobenzimidazole, 2-mercaptomethylbenzimidazole or a zinc salt of 2-mercaptobenzimidazole; a dithiocarbamate type age resister such as nickel dibutyldithiocarbamate; a thiourea type age resister such as 1,3-bis(dimethylaminopropyl)-2-thiourea or tributyl thiourea; and an orgaic thio acid type such as dilauryl thiodipropionate. Example of the phosphite type age resister includes tris(nonylphenyl)phosphite.

In the rubber composition according to this embodiment, carbon black and/or silica can be used as a reinforcing filler. In other words, the reinforcing filler may be carbon black alone, may be silica alone and may be a combination of carbon black and silica. Carbon black or a combination of carbon black and silica is preferably used. The content of the reinforcing filler is not particularly limited, and is, for example, preferably 10 to 150 parts by mass, more preferably 20 to 100 parts by mass and more preferably 30 to 80 parts by mass, per 100 parts by mass of the rubber component.

The carbon black is not particularly limited and conventional various kinds can be used. The content of the carbon black is preferably 10 to 80 parts by mass and more preferably 10 to 70 parts by mass, per 100 parts by mass of the rubber component.

The silica is not particularly limited, but wet silica such as wet precipitated silica or wet gelled silica is preferably used. When the silica is contained, its content is preferably 1 to 70 parts by mass and more preferably 5 to 60 parts by mass, per 100 parts by mass of the rubber component from the standpoints of balance of tan δ of rubber, reinforcing properties and the like.

When the silica is contained, a silane coupling agent such as sulfide silane or mercaptosilane may be further contained. When the silane coupling agent is contained, its content is preferably 2 to 20 mass % based on the silica content.

In addition to the above components, compounding ingredients used in general rubber industries, such as a process oil, zinc flower, stearic acid, a softener, a plasticizer, a wax, a vulcanizing agent and a vulcanization accelerator can be appropriately added in the general range to the rubber composition according to this embodiment.

Examples of the vulcanizing agent include sulfur components such as powdered sulfur, precipitated sulfur, colloidal sulfur, insoluble sulfur and highly dispersible sulfur. Although not particularly limited, the content of the vulcanizing agent is preferably 0.1 to 10 parts by mass and more preferably 0.5 to 5 parts by mass, per 100 parts by mass of the rubber component. The content of the vulcanization accelerator is preferably 0.1 to 7 parts by mass and more preferably 0.5 to 5 parts by mass, per 100 parts by mass of the rubber component.

The rubber composition according to this embodiment can be produced by kneading the necessary components according to the conventional method using a mixing machine generally used, such as Banbury mixer, a kneader or rolls. Specifically, additives excluding a vulcanizing agent and a vulcanization accelerator are added to the rubber component, followed by mixing, in a first mixing step, and a vulcanizing agent and a vulcanization accelerator are added to the mixture obtained, followed by mixing, in a final mixing step. Thus, a rubber composition can be prepared.

Although not particularly limited, the rubber composition thus obtained is preferably used in a sidewall part. For example, the rubber composition is extrusion-molded into a predetermined cross-sectional shape corresponding to a sidewall part. Alternatively, a ribbon-shaped rubber strip comprising the rubber composition is spirally wound on a drum to form a cross-sectional shape corresponding to a sidewall part. Thus, an unvulcanized sidewall member is obtained. The sidewall member is fabricated into a tire shape together with other tire members constituting a tire, such as an inner liner, a carcass, a belt, a bead core, a bead filler and a tread, according to the conventional method. Thus, a green tire (unvulcanized tire) is obtained. The green tire thus obtained is vulcanization-molded at, for example, 140 to 180° C. according to the conventional method. Thus, a pneumatic tire having the sidewall member is obtained.

The kind of the pneumatic tire according to this embodiment is not particularly limited, and examples of the pneumatic tire include various tires such as tires for passenger cars and heavy load tires for trucks, buses and the like.

### EXAMPLES

Examples of the present invention are described below, but the present invention is not construed as being limited to those examples.

### Synthesis Example 1 of Hydrogenated Copolymer

2.5 L of cyclohexane, 50 g of tetrahydrofuran, 0.12 g of n-butyl lithium, 100 g of styrene and 400 g of 1,3-butadiene were put in a nitrogen-substituted heat-resistant reactor, and polymerization was conducted at a reaction temperature of 50° C. After completion of the polymerization, 1.7 g of N,N-bis(trimethylsilyl)aminopropylmethyl diethoxysilane was added, a reaction was conducted for 1 hour and hydrogen gas was then supplied under a pressure of 0.4 MPa-gauge. The reaction was conducted at a reaction temperature of 90° C. under a hydrogen gas supply pressure of 0.7 MPa-gauge using a catalyst mainly comprising titanocene dichloride until reaching a target hydrogenation ratio. Solvent was removed to obtain hydrogenated copolymer 1.

The hydrogenated copolymer obtained had a weight average molecular weight by GPC of 350,000 in terms of polystyrene based on standard polystyrene. The measurement was conducted using “LC-10A” manufactured by Shimadzu Corporation as a measuring instrument using “PLgel-MIXED-C” manufactured by Polymer Laboratories as a column, using a differential refractive index detector (RI) as a detector and using THF as a solvent under the conditions that a measurement temperature is 40° C., a flow rate is 1.0 mL/min, a concentration is 1.0 g/L and an injection amount is 40 μL. The amount of bonded styrene was 20 mass % and the hydrogenation ratio of the butadiene moiety was 90 mol %. The amount of the bonded styrene was obtained from a spectrum intensity ratio of proton based on styrene unit and proton based on butadiene unit (containing hydrogenated portion) using H¹-NMR.

### Synthesis Example 2 of Hydrogenated Copolymer

Hydrogenated copolymer 2 was obtained by the same method as Synthesis Example 1, except for changing the reaction time for hydrogenation and changing the target hydrogenation ratio. The hydrogenated copolymer 2 obtained had a weight average molecular weight of 350,000 in terms of polystyrene based on standard polystyrene. The amount of bonded styrene was 20 mass % and the hydrogenation ratio of the butadiene moiety was 80 mol %.

### EXAMPLES AND COMPARATIVE EXAMPLES

Using a Banbury mixer, components excluding a vulcanization accelerator and sulfur were added according to the formulations (parts by mass) shown in Table 1 below, followed by mixing, in a first mixing step (non-processing kneading step) (discharge temperature: 160° C.). A vulcanization accelerator and sulfur were added to the mixture obtained, followed by mixing, in a final mixing step (processing kneading step) (discharge temperature: 90° C.). Thus, a rubber composition was prepared.

The details of each component in Table 1 are as follows.

Hydrogenated SBR 1: Hydrogenated copolymer 1 prepared according to Synthesis Example 1

Hydrogenated SBR 2: Hydrogenated copolymer 2 prepared according to Synthesis Example 2

NR: RSS#3

BR: “BR150B” manufactured by Ube Industry, Co., Ltd.

Carbon black: “SEAST 3” manufactured by Tokai Carbon Co., Ltd.

Oil: “PROCESS NC140” manufactured by JX Nippon Oil & Sun Energy Corporation

Zinc flower: “Zinc Flower #1” manufactured by Mitsui Mining & Smelting Co., Ltd.

Stearic acid: “LUNAC S-20” manufactured by Kao Corporation

Chemical age resister: “NOCRAC 6C” manufactured by Ouchi Shinko Chemical Industrial Co., Ltd.

Sulfur: “Powdered Sulfur” manufactured by Tsurumi Chemical Industry Co., Ltd.

Vulcanization accelerator: “NOCCELER NS-P” manufactured by Ouchi Shinko Chemical Industrial Co., Ltd.

Each rubber composition obtained was vulcanized at 160° C. for 30 minutes to prepare each test piece having a thickness of 2 mm, and appearance (brown discoloration and yellow discoloration) and ozone resistance of each test piece were evaluated. The evaluation methods are as follows.

Appearance: A test piece was irradiated with sunlight outdoor, and the surface of the test piece before irradiation (outdoor exposure: 0 day) and after 40 days (outdoor exposure: 40 days) was visually observed. The appearance was evaluated by following five-grade criteria.

5: Surface is black, and discoloration is not substantially observed

4: Surface is slightly discolored brown or yellow

3: Less than half of the whole is discolored brown or yellow

2: The half or more of the whole is discolored brown or yellow

1: Surface is wholly discolored brown or yellow.

Ozone resistance: A test piece was installed in an ozone weather meter under the condition of 25% elongation, and was allowed to stand therein in the environment of an ozone concentration of 100 pphm and a temperature of 50° C. for 24 hours. Thereafter, generation state of cracks was observed visually and by a magnifying glass of 10 magnifications, and ozone resistance was evaluated by the following four-grade criteria.

4: No generation of cracks

3: Cracks that cannot be confirmed with naked eye but can be confirmed with a magnifying glass of 10 magnifications are generated

2: Cracks of 1 mm or less are generated

1: Cracks exceeding 1 mm are generated

TABLE 1

| | Com. Ex. 1 | Com. Ex. 2 | Com. Ex. 3 | Ex. 1 | Ex. 2 | Ex. 3 | Ex. 4 |
|---|---|---|---|---|---|---|---|
| Hydrogenated SBR 1 | — | — | — | 80 | 80 | 100 | — |
| Hydrogenated SBR 2 | — | — | — | — | — | — | 100 |
| NR | 50 | 50 | 50 | — | 20 | — | — |
| BR | 50 | 50 | 50 | 20 | — | — | — |
| Carbon black | 60 | 60 | 60 | 60 | 60 | 60 | 60 |
| Zinc flower | 3 | 3 | 3 | 3 | 3 | 3 | 3 |
| Stearic acid | 2 | 2 | 2 | 2 | 2 | 2 | 2 |
| Chemical age resister | 3 | 5 | 0 | 0 | 0 | 0 | 0 |
| Sulfur | 2 | 2 | 2 | 2 | 2 | 2 | 2 |
| Vulcanization | 1 | 1 | 1 | 1 | 1 | 1 | 1 |
| accelerator | | | | | | | |
| Appearance | 3 | 1 | 5 | 5 | 5 | 5 | 5 |
| Ozone resistance | 2 | 3 | 1 | 3 | 3 | 4 | 3 |

The results are shown in Table 1. It is recognized from the comparison between Comparative Examples 1 to 3 and Examples 1 to 4 that the rubber composition containing the predetermined hydrogenated SBR can have both ozone resistance and good appearance by that a chemical age resister is not substantially contained.

It is understood from the comparison between Comparative Example 1 and Comparative Example 2 that when the amount of the chemical age resister is increased, appearance is deteriorated.

It is understood from the comparison between Comparative Example 1 and Comparative Example 3 that when the chemical age resister is not added in the rubber composition that does not contain the predetermined hydrogenated SBR, ozone resistance is deteriorated. Industrial applicability

The rubber composition for a tire of the present invention can be used in various tires of passenger cars, light trucks, buses and the like.

1. A rubber composition for a tire comprising a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more,
wherein the rubber composition does not substantially contain a chemical age resister.

2. The rubber composition for a tire according to claim 1, wherein the content ratio of the hydrogenated copolymer in the rubber component is 80 mass % or more.

3. The rubber composition for a tire according to claim 1, which is for use in a sidewall.

4. A pneumatic tire manufactured using the rubber composition for a tire according to claim 1.

5. The rubber composition for a tire according to claim 2, which is for use in a sidewall.

6. A pneumatic tire manufactured using the rubber composition for a tire according to claim 2.

7. A pneumatic tire manufactured using the rubber composition for a tire according to claim 3.

8. A pneumatic tire manufactured using the rubber composition for a tire according to claim 5.
